(19) United States
(12) Patent Application Publication
(10) Pub. No.: US 2011/0119758 A1
(43) Pub. Date: May 19, 2011

(54) APPARATUS FOR MOBILE DATA PROCESSING

(75) Inventors: Joerg Uterhardt, Hoenow (DE); Thomas Wardin, Bergisch Gladbach (DE)

(73) Assignee: DEUTSCHE TELEKOM AG, Bonn (DE)

(21) Appl. No.: 12/992,117

(22) PCT Filed: Feb. 16, 2009
(86) PCT No.: PCT/DE09/00213

§ 371 Date: Feb. 3, 2011

(30) Foreign Application Priority Data
May 13, 2008 (DE) 10 2008 023 245.9
May 28, 2008 (DE) 10 2008 025 660.9

(51) Int. Cl. H04L 9/32; G06F 15/177

(52) U.S. Cl. 726/17; 713/2

(57) ABSTRACT

A mobile data processing device includes a permanent memory configured to store an operating system bootable from the permanent memory. The device includes a connection configured to connect the device and a personal computer. The connection is configured so that the personal computer loads the operating system from the permanent memory during booting. The device includes at least one integrated network adapter. The device includes a hardware system. The hardware system is configured to at least one of encrypt and decrypt content stored in the permanent memory. The device includes a housing configured to be portable.

### CROSS-REFERENCE TO RELATED APPLICATIONS

This application is a U.S. National Phase application under 35 U.S.C. § 371 of International Application No. PCT/DE2009/000213, filed on Feb. 16, 2009, and claims benefit to German Patent Application Nos. 10 2008 023 245.9, filed on May 13, 2008, and 10 2008 025 660.9, filed on May 28, 2008. The International Application was published in German on Nov. 19, 2009 as WO 2009/138047 A1 under PCT Article 21(2).

### FIELD

The invention concerns a memory system with additional functions, with which mobile data processing is made possible.

### BACKGROUND

Mobile computing is steadily increasing in importance. Oftentimes, data are carried from one computer to another in portable fashion by memory sticks (such as USB flash memory). While processing hitherto has always taken place under control of the host PC, which is to say the booting of the operating system, and thus its weaknesses and the potential for attack from a USB stick had to be viewed as a cumulative security risk, an approach is to be selected that simplifies the process of authorization and the processing of data through the use of a memory stick (such as a USB stick) and offers a higher level of security.

### SUMMARY

The present invention provides a mobile data processing device. The device includes a permanent memory configured to store an operating system stored in the permanent memory and bootable therefrom. The device includes a connection configured to connect the device and a personal computer. The connection is configured so that the personal computer loads the operating system from the permanent memory during booting. The device includes at least one integrated network adapter. The device includes a hardware system. The hardware system is configured to at least one of encrypt and decrypt a content of the permanent memory. The device includes a housing configured to enable user pocket portability of the device.

### BRIEF DESCRIPTION OF THE DRAWINGS

The figures, which show a possible embodiment, are described below. They show:

FIG. 1 the arrangement of the components and their connection in the system.

FIG. 2 the exterior of the device with its connections.

### DETAILED DESCRIPTION

One embodiment of the invention includes the features of the independent claim.

In principle, the key can be used in all fields that involve login processes and the processing of data using IT systems.

The combination of these components:
a. Login and security, firewall, virus protection and child protection
b. USB SLC flash memory>=8 GB, preferably with multiple partitions
c. Integrated WLAN adapter
d. Integrated Ethernet chip for Ethernet connection via RJ45
e. Biometric finger scanner
f. USB memory with hardware-supported data encryption, preferably 256-bit AES ad hoc encryption
   in a system in this form is one way of providing a maximum degree of security and independence.

The device is personalized and can provide primary functions such as
a. Authentication device
b. Local data storage
c. Local work environment (operating system, selected application programs such as, e.g., MS Office, dictionaries, browser, etc).

Access to the system and to possible Internet platforms can take place in two stages: The operating system stored on the disk (such as Windows XP or the like) boots automatically. At first startup, a personalized certificate can be issued and is associated on the server side with the finger scan. A security certificate can be required for each individual device in order to make the login process via fingerprint secure. Alternative approaches, such as the generation of a local certificate, are conceivable.

In all logins that follow, the certificate and finger scan of the user take the place of the insecure and inconvenient login with user name and password. However, if the user wishes to login in the known manner with user name and password, this is made possible for him.

In order to make operation as simple as possible, the device can be operated via simple USB cable. If energy consumption is greater, a USB Y-cable can be used. In the event that power is insufficient and only one USB interface is available, a USB hub with an external power supply is offered as an option. The cable can be integrated into the housing in a flexible manner. In addition, an integrated LED indicates the status of the power supply; (when the LED lights green, there is no problem; if it does not light, the power supplied through the USB port is insufficient).

Furthermore, an additional LED with a red light can indicate the status of the data transmission in order to reduce the probability of any damage and data losses caused by improper handling.

It is possible to integrate an SD card slot in future. The idea behind this is in the future to offer data preinstalled on SD cards, which can then be used immediately.

In accordance with current technical capabilities, the first generation device can have 8 GB memory capacity in one layer. For a long service life, SLC flash chips can be used at present. However, new chip developments do not preclude a higher capacity and a different technology in the future. The possible use of a second layer PCB would make it possible to double the particular capacity. For the time being, however, 8 GB memory space can suffice.

Color coding can be provided for the housing and for connections to prevent operating errors to the greatest extent possible.

The WLAN antenna can be integrated in the housing. The device can be switched off with additional software through a secured Internet connection. A backup version of the local software (corresponding to the condition on delivery) is present in a partition that is inaccessible to the user, allowing the device to be reset through the network by service personnel.

In one possible embodiment, it is a USB SSD with biometric fingerprint sensor
a. SSD with minimum 8 GB SLC NAND flash chips, partitioned, ensures high reliability and speed
b. Preinstalled operating system permits the use of additional applications and booting from the USB SSD
c. 10/100 base T Ethernet and 802.11a/b/g WLAN for connection to the Internet and intranet
d. USB hub controller—fully compatible with USB2.0 high-speed
e. USB flash disk controller with biometric fingerprint sensor
f. E-field sweep type fingerprint sensor
g. The advanced fingerprint recognition technology makes it possible to log into Internet platforms with very high security and great convenience.
h. Unique identification of the user at login
i. The possible housing dimensions are
   a. 95 mm×71.5 mm×15.5 mm (H)
j. PCB (circuit board) size
   a. 88.35 mm×65.00 mm
      However, these do not represent any limitation.

A maximum degree of security is provided by the invention, and all vulnerable components of the host PC remain unused and hence protected from any change.

With the invention, requirements can be simultaneously fulfilled that previously could not be fulfilled or could not be fulfilled by a single device:
a. Security through the combination of certificate (that cannot be manipulated by the user) and finger scan (only possible for the user).
b. Location-independence due to usability with any desired host PC, because only “neutral” devices thereof are used, such as working memory and processor, graphics card and screen, keyboard, and mouse, but no local drives.
c. Lighter than an ultra-mobile PC, hence “always at hand”
d. Consistency, a defined scope of user data on the key, background data and additional applications on an Internet platform, resulting in working conditions that are the same at all times and in all places

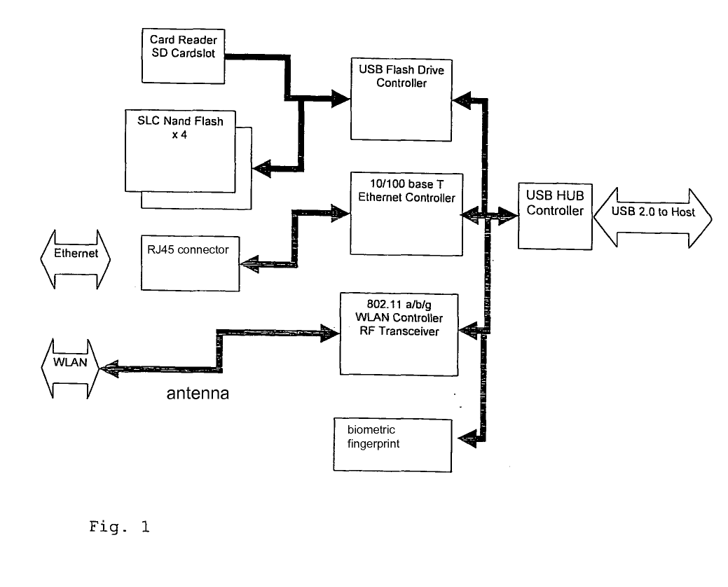

FIG. 1 shows the individual components of the device and their connection. A central USB hub is located in the device; this communicates with the computer through the USB bus. A second USB connection, which is not shown separately here, can be used in the event of increased energy demand. In an embodiment that is not shown, a USB hub with a power supply can additionally be interposed if the power supplied by one USB connection is not sufficient. The controllers for the permanent memory, the Ethernet adapter, and the WLAN adapter are connected directly to the internal USB hub. The fingerprint sensor is connected directly to the permanent memory. The flash drive controller also has the task of presenting the flash memory to the operating system as a hard disk. The network controllers are then connected in turn to appropriate connections.

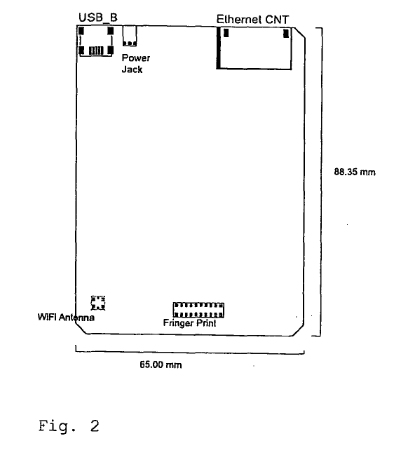

FIG. 2 shows the housing with possible connections. The housing has a USB connection, a power supply connection, a fingerprint sensor, and an Ethernet connection. The WLAN antenna is integrated in the housing. The size is approximately 6.5 cm×9 cm. The location of the LED status indicators is not shown here.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-12. (canceled)

13. A mobile data processing device, the device comprising:
a permanent memory configured to store an operating system bootable therefrom;
a connection configured to connect the device and a personal computer, the connection configured so that the personal computer loads the operating system from the permanent memory during booting;
at least one integrated network adaptor;
a hardware system configured to at least one of encrypt and decrypt a content of the permanent memory; and
a housing configured to enable user pocket portability of the device.

14. The mobile data processing device of claim 13, wherein the permanent memory is a flash memory.

15. The mobile data processing device of claim 13, wherein the device is configured to control access thereto by at least one of an integrated biometric finger scanner, a password, and a software certificate.

16. The mobile data processing device of claim 15, wherein the software certificate is personalized.

17. The mobile data processing device of claim 13, wherein the at least one integrated network adapter is a WLAN adapter.

18. The mobile data processing device of claim 13, wherein the at least one integrated network adapter is an Ethernet adapter.

19. The mobile data processing device of claim 18, wherein the Ethernet adapter comprises an integrated Ethernet chip and is configured to operate using an RJ45 connector.

20. The mobile data processing device of claim 13, wherein the connection is a USB connection.

21. The mobile data processing device of claim 15, wherein the connection is a USB connection and wherein the at least one of an integrated biometric finger scanner, a password, and a software certificate is configured to connect to the personal computer via the USB connection.

22. The mobile data processing device of claim 20, further comprising a USB hub.

23. The mobile data processing device of claim 13, further comprising at least one of a firewall, a virus protection and a child protection.

24. The mobile data processing device of claim 13, wherein the permanent memory is configured with hardware-supported encryption of at least 256 bits.

25. The mobile data processing device of claim 16, wherein the device is configured to control a first access thereto through the personal software certificate and a server-side association with an individual finger scan; and the device is configured to control a subsequent access thereto based on the personal software certificate and a comparison of the individual finger scan with a stored finger scan.

26. The mobile data processing device of claim 13, wherein the housing is smaller than 20 cm×20 cm.

27. The mobile data processing device of claim 26, wherein the housing is smaller than 9.5 cm×7.15 cm×1.5 cm.

28. The mobile data processing device of claim 13, wherein data and applications of the device are configured to be updated through a secured Internet connection.

29. The mobile data processing device of claim 13, wherein the device is configured to enable return to a delivery condition using a remote login.
